(19) United States
(12) Patent Application Publication
(10) Pub. No.: US 2009/0018230 A1
(43) Pub. Date: Jan. 15, 2009

(54) Yellow radiation curing inks

(76) Inventors: Greig Chisholm, Glasgow (GB); Janie-Anne Pickrell, Glasgow (GB); Kathryn Nicoll, Glasgow (GB)

Correspondence Address: JoAnn Villamizar;Patent Department, Ciba Corporation, 540 White Plains Road, P.O. Box 2005, Tarrytown, NY, 10591-9005, US

(21) Appl. No.: 12/217,552

(22) Filed: Jul. 7, 2008

(30) Foreign Application Priority Data
Jul. 12, 2007 (EP) 07112345.9

(51) Int. Cl. C08K 5/23; C09D 11/02

(52) U.S. Cl. 522/78

(57) ABSTRACT

A radiation curing ink comprising from 60 to 90% of an acrylic binder, optionally reactive diluents and/or non-reactive resins, from 1 to 20% of a photoinitiator and optionally a sensitizer, from 5 to 25% of a pigment of the formula

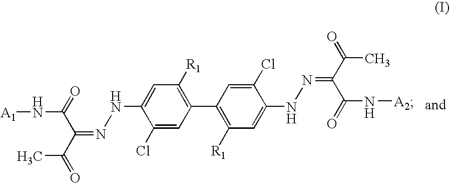

from 0.5 to 2.5% of a pigment of the formula

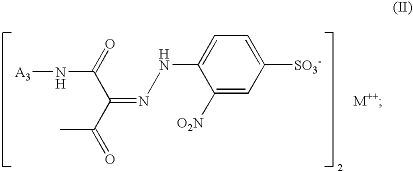

in which formulae (I) and (II) A₁, A₂ and A₃ are each independently from each other selected aromatic and substituted aromatic groups and R₁ is H or Cl, and M⁺⁺ is Be⁺⁺, Mg⁺⁺, Ca⁺⁺, Sr⁺⁺ or Ba⁺⁺. The invention also pertains to pigment blends and millbases (ink concentrates), as well as their manufacture and their use for preparing especially flexographic or lithographic radiation curing inks. Polychrome ink sets are also claimed.

Full colour flexographic or lithographic printing is generally based on four colours, each of which must have a precise hue (shade). It is highly desirable to match the hue and getting high transparency while improving the colour strength, the gloss and the rheology, especially in radiation curing flexographic or lithographic inks. However, tiny well-dispersed pigment particles usually lead to higher viscosity. This is especially a problem with diarylide yellow azo pigments.

It has now been found that it is surprisingly possible to improve simultaneously the colour strength, rheology and gloss of yellow radiation curing inks when particular yellow pigment compositions are used.

WO-2005/056694 and WO-2005/056695 disclose pigment preparations based on C.I. Pigment Yellow 74, which further comprise C.I. Pigment Yellow 62 as a dispersing agent. These compositions are disclosed to be useful for plastics, binders, coatings, paints, electrophotographic toners and developers, electret materials, colour filters as well as in inks, printing inks and seeds, especially in aqueous systems. However, such pigment preparations prove to have a very low colour strength and the hue is not satisfactory for 4-colour printing. Their rheology is satisfactory only at low pigment levels. Therefore, they do not fulfil all requirements for lithographic and flexographic inks, especially the essential simultaneous combination of superior hue and high colour strength, gloss, fastness and fluidity.

JP-A-S47/050 767 discloses pigment compositions comprising for example 3,3′-dichlorobenzidine azo pigments and monoazo pigments comprising a carboxy group.

EP-0 517 513 discloses a process for the production of pigments, especially for use in nitrocellulose-based liquid packaging inks, wherein arylamide pigments are first subjected to a dyestuff treatment with a tetrazo dye comprising water-soluble groups, then after-treating under alkaline conditions at elevated temperature.

U.S. Pat. No. 3,759,733 discloses monoazo pigment compositions comprising water-soluble coupled dyestuffs, in example 14 C.I. Pigment Yellow 74 and the free sulfonic acid precursor of C.I. Pigment Yellow 168.

GB-2 364 322 discloses monoazo compounds, the coupling part of which is substituted with a sulfonic acid group or a salt thereof. These compounds are used as dispersants in aqueous inks, especially ink jet inks, for example in combination with C.I. Pigment Yellow 74, which is a structurally closely similar monoazo pigment.

EP 0 079 303 discloses a storage stabilized, opaque form of C.I. Pigment Yellow 74. Opacity, however, is totally inadequate in 4-colour printing technology.

U.S. Pat. No. 3,776,749 discloses diarylide pigment compositions comprising water-soluble coupled diarylide dyestuffs.

RU-2 069 678 discloses pigment compositions comprising 3,3′-dichlorobenzidine azo pigments and sulfonated derivatives thereof. Allegedly, this provides enhanced staining capacity, transparency and resistance to recrystallisation in polygraphic dyes.

U.S. Pat. No. 2005/0 164121 discloses masks for photoresists which may comprise, amongst many other pigments, C.I. Pigment Yellow 13 or C.I. Pigment Yellow 168. However, it fails to teach or suggest the combination thereof, and the light-blocking mask composition is not UV-curable because it must remain developable.

WO-02/08346 discloses a method for coating substrates, characterized in that selected binders are used. C.I. Pigment Yellow 13 is mentioned as one of many suitable pigments.

C.I. Pigment Yellow 13 has been used in flexographic and lithographic inks, too. However, its poor rheology in such systems remains a serious problem, so that all requirements could not be simultaneously fulfilled to a satisfactory degree with the prior art compositions. With the only exception of JP-A-S47/050767, all previous proposals followed the rule of thumb (valid for many pigment classes), that any additives should be based on a chromophore of structure similar to that of the pigment, the properties of which should be improved.

It has now been found that, on the contrary, this long lasting problem can be resolved for radiation curing, especially flexographic or lithographic inks by simply blending selected yellow 3,3′-dichlorobenzidine disazo pigments with selected monoazo yellow pigment lakes bridged by a divalent earth alkaline metal.

Thus, the invention relates to a radiation curing ink comprising
from 60 to 90% of a binder comprising at least one oligomeric component comprising acrylic bonds, optionally one or a plurality of reactive diluents and optionally one or a plurality of resins;
from 1 to 20%, preferably from 3 to 15%, most preferred from 4 to 10%, of a photoinitiator and optionally a sensitizer;
from 5 to 25%, preferably from 7.5 to 15%, especially from 9 to 13%, most preferred from 10 to 12%, of a pigment of the formula

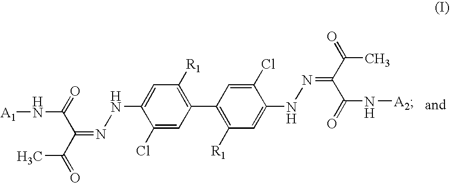

from 0.5 to 2.5% of a pigment of the formula

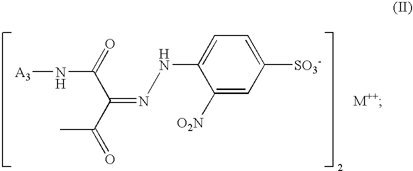

in which formulae (I) and (II) A₁, A₂ and A₃ are each independently from each

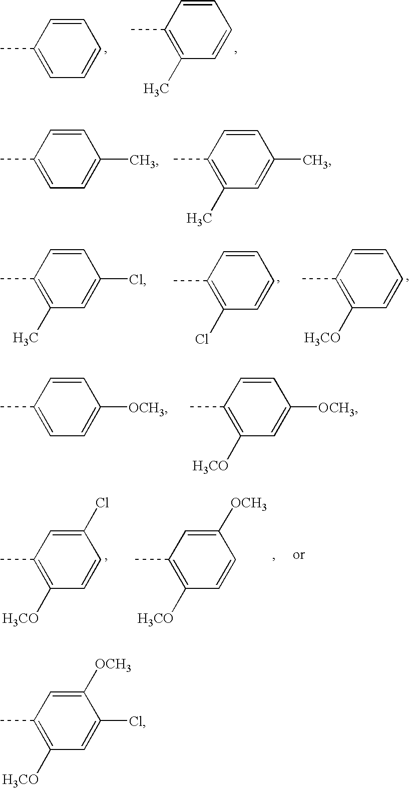

R₁ is H or Cl, preferably H, and M⁺⁺ is Be⁺⁺, Mg⁺⁺, Ca⁺⁺, Sr⁺⁺ or Ba⁺⁺;
all % by weight, based on the total weight of the radiation curing ink.

The pigments of formulae (I) or (II) may also consist of mixtures of pigmentary particles of different structures according to formulae (I) or (II), respectively. Such mixtures can be obtained by mixing or by mixed synthesis starting simultaneously or sequentially from several diazo and/or coupling starting materials.

The function of the photoinitiator is to initiate the polymerisation reaction which will cure the ink film. Typically, the photoinitiator is chosen from the group consisting of radical photoinitiators, cationic photoinitiators (latent acids) and anionic photo-initiators (latent bases), and mixtures thereof. Radical photoinitiators are preferred.

Suitable radical photoinitiators are known to the person skilled in the art and commercially available in a wide variety and subject of many publications. Typical examples are hydroxy ketones and amino ketones, such as camphor quinone, benzophenone, benzophenone derivatives (e.g. 2,4,6-trimethylbenzophenone, 2-methylbenzophenone, 3-methylbenzophenone, 4-methyl-benzophenone, 2-methoxycarbonylbenzophenone 4,4′-bis(chloromethyl)benzophenone, 4-chlorobenzophenone, 4-phenylbenzophenone, 3,3′-dimethyl-4-methoxy-benzophenone, [4-(4-methylphenylthio)phenyl]-phenylmethanone, methyl-2-benzoylbenzoate, 3-methyl-4′-phenylbenzophenone, 2,4,6-trimethyl-4′-phenylbenzophenone, 4,4′-bis(dimethylamino)-benzophenone or 4,4′-bis(diethylamino)benzophenone); ketal compounds, as for example benzildimethylketal (IRGACURE® 651); acetophenone, acetophenone derivatives (e.g. hydroxycycloalkyl phenyl ketones, hydroxyalkyl phenyl ketones, α-hydroxy-acetophenone, α-aminoacetophenone or dialkoxy-acetophenones, for example 2-hydroxy-2-methyl-1-phenyl-propanone (DAROCUR® 1173), 1-hydroxy-cyclohexyl-phenyl-ketone (IRGACURE® 184), 1-(4-dodecylbenzoyl)-1-hydroxy-1-methyl-ethane, 1-(4-isopropylbenzoyl )-1-hydroxy-1-methyl-ethane, 1-[4-(2-hydroxyethoxy)-phenyl]-2-hydroxy-2-methyl-1-propan-1-one (IRGACURE® 2959); 2-hydroxy-1-{4-[4-(2-hydroxy-2-methyl-propionyl)-benzyl]-phenyl}-2-methyl-propan-1-one (IRGACURE® 127); 2-hydroxy-1-{4-[4-(2-hydroxy-2-methyl-propionyl)-phenoxy]-phenyl}-2-methyl-propan-1-one), (4-methylthiobenzoyl)-1-methyl-1-morpholinoethane (IRGACURE® 907), (4-morpholinobenzoyl)-1-benzyl-1-dimethyl-aminopropane (IRGACURE® 369), (4-morpholinobenzoyl)-1-(4-methylbenzyl)-1-dimethyl-aminopropane (IRGACURE® 379), 4-(2-hydroxyethyl)aminobenzoyl)-1-benzyl-1-dimethyl-aminopropane or 2-benzyl-2-dimethylamino-1-(3,4-dimethoxyphenyl)butanone-1), 4-aroyl-1,3-dioxolanes, benzoin alkyl ethers and benzil ketals (e.g. dimethyl benzil ketal), phenylglyoxalic esters and derivatives thereof (e.g. oxo-phenyl-acetic acid), dimeric phenylglyoxalic esters (e.g. oxo-phenyl-acetic acid, 1-methyl-2-[2-(2-oxo-2-phenyl-acetoxy)-propoxy]-ethyl ester (IRGACURE® 754)); oximeesters (e.g. 1,2-octanedione 1-[4-(phenylthio)phenyl]-2-(O-benzoyloxime (IRGACURE® OXE01), ethanone 1-[9-ethyl-6-(2-methylbenzoyl )-9H-carbazol-3-yl]-1-(O-acetyloxime) (IRGACURE® OXE02), 9H-thioxanthene-2-carboxaldehyde 9-oxo-2-(O-acetyloxime)); peresters, (e.g. benzophenone tetracarboxylic peresters as described in EP-A-0 126 541), monoacyl phosphine oxides (e.g. (2,4,6-trimethylbenzoyl)diphenylphosphine oxide (DAROCUR® TPO), ethyl(2,4,6 trimethylbenzoylphenyl)phosphinic acid ester), bisacylphosphine oxides (e.g. bis(2,6-dimethoxy-benzoyl)-(2,4,4-trimethyl-pentyl)-phosphineoxide), bis-(2,4,6-trimethylbenzoyl)-phenylphosphine oxide (IRGA-CURE® 819), bis(2,4,6-trimethylbenzoyl)-2,4-dipentoxy-phenylphosphine oxide), trisacylphosphine oxides, halomethyltriazines (e.g. 2-[2-(4-methoxy-phenyl)-vinyl]-4,6-bis-trichloromethyl-[1,3,5]triazine, 2-(4-methoxy-phenyl)-4,6-bis-trichloromethyl-[1,3,5]triazine, 2-(3,4-dimethoxy-phenyl)-4,6-bis-trichloromethyl-[1,3,5]triazine, 2-methyl-4,6-bis-trichloromethyl-[1,3,5]triazine), hexaarylbisimidazole/coinitiators systems (e.g. ortho-chlorohexaphenyl-bisimidazole combined with 2-mercaptobenzthiazole), ferrocenium compounds, or titanocenes (e.g. bis(cyclopentadienyl)-bis(2,6-difluoro-3-pyrryl-phenyl)-titanium (IRGACURE® 784)). Further, borate compounds can be used as coinitiators.

The DAROCUR® and IRGACURE® compounds are available from Ciba Inc., Basel/CH.

Cationic photoinitiators are for example benzoyl peroxide, other suitable peroxides such as described in U.S. Pat. No. 4,950,581 (column 19/lines 17-25), nitriles, aromatic sulfonium, oximesulfonates or phosphonates, or phosphonium or iodonium salts, such as described in U.S. Pat. No. 4,950,581 (column 18/line 60-column 19/line 10).

Commercial suitable sulfonium salts are for example Cyracure® UVI-6990 (Dow), Cyracure® UVI-6974 (Dow), Degacure® KI 85 (Degussa), SP-55, SP-150, SP-170 (Asahi Denka), GE UVE 1014 (General Electric), SarCate KI-85 (triarylsulfonium hexafluorophosphate, Sartomer), SarCat® CD 1010 (mixed triarylsulfonium hexafluoroantimonate; Sartomer); SarCat® CD 1011 (mixed triarylsulfonium hexafluorophosphate; Sartomer).

Suitable iodonium salts are for example tolylcumyliodonium tetrakis(pentafluorophenyl)borate, 4-[(2-hydroxy-tetradecyloxy)phenyl]phenyliodonium hexafluoroantimonate or hexafluoro-phosphate (SarCat® CD 1012; Sartomer), tolylcumyliodonium hexafluoro-phosphate, 4-isobutyl-phenyl-4′-methylphenyliodonium hexafluorophosphate (IRGACURE® 250, Ciba), 4-octyloxyphenyl-phenyliodonium hexafluorophosphate or hexafluoroantimonate, bis-(dodecylphenyl)iodonium hexafluoroantimonate or hexafluorophosphate, bis(4-methylphenyl)iodonium hexa-fluorophosphate, bis(4-methoxyphenyl)iodonium hexafluorophosphate, 4-methyl-phenyl-4′-ethoxyphenyliodonium hexafluorophosphate, 4-methylphenyl-4′-dodecyl-phenyliodonium hexafluorophosphate, 4-methylphenyl-4′-phenoxyphenyliodonium hexafluorophosphate. Of all these iodonium salts, compounds with other anions are, of course, also suitable. The preparation of iodonium salts is known to the person skilled in the art and described for example in U.S. Pat. No. 4,151,175, U.S. Pat. No. 3,862,333, U.S. Pat. No. 4,694,029, EP-0562897, U.S. Pat. No. 4,399,071, U.S. Pat. No. 6,306,555, WO-98 /46647; J. V. Crivello, “Photoinitiated Cationic Polymerization” in: UV Curing: Science and Technology, Editor S. P. Pappas, pages 24-77, Technology Marketing Corporation, Norwalk, Conn. 1980, ISBN 0-686-23773-0; J. V. Crivello, J. H. W. Lam, Macromolecules 10, 1307 [1977]; J. V. Crivello, Ann. Rev. Mater. Sci. 1983/13, pages 173-190 and J. V. Crivello, Journal of Polymer Science, Part A: Polymer Chemistry, Vol. 37, 4241-4254 [1999].

Suitable nitriles are for example α-(octylsulfonyloxyimino)-4-methoxybenzylcyanide, 2-methyl-α-[3-[4-[[methyl-sulfonyl]oxy]imino]-2(3H )-thienylidene]-benzeneacetonitrile, 2-methyl-α-[3-[4-[[(n-propyl)sulfonyl]oxy]imino]-2(3H)-thienylidene]-benzeneacetonitrile, 2-methyl-α-[2-[4-[[(camphoryl)sulfonyl]oxy]imino]-2(3H)-thienylidene]-benzeneacetonitrile, 2-methyl-α-[3-[4-[[(4-methylphenyl)sulfonyl]oxy]imino]-2(3H )-thienylidene]-benzeneacetonitrile, 2-methyl-α-[3-[4-[[(n-octyl)sulfonyl]oxy]imino]-2(3H)-thienylidene]-benzeneacetonitrile or 2-methyl-α-[3-[[[[4-[[(4-methylphenyl)-sulfonyl]oxy]phenyl]sulfonyl]oxy]imino]-2(3H)-thienylidene]-benzeneacetonitrile.

Oxime sulfonates are for example 1,1′-[1,3-propanediylbis(oxy-4,1-phenylene)]-bis[2,2,2-trifluoro-bis[O-(trifluoromethylsulfonyl)oxime]-ethanone, 1,1′-[1,3-propanediylbis(oxy-4,1-phenylene)]bis[2,2,2-trifluoro-bis[O-(propylsulfonyl)oxime]-ethanone, 1,1′-[1,3-propanediylbis(oxy-4,1-phenylene)]bis[2,2,2-trifluoro-bis[O-((4-methylphenyl)sulfonyl)oxime]-ethanone, 2-[2,2,3,3,4,4,5,5,6,6,7,7-dodecafluoro-1-(nonafluorobutylsulfonyloxyimino)-heptyl]-fluorene, 2-[2,2,3,3,4,4,4-heptafluoro-1-(nonafluorobutylsulfonyloxyimino)-butyl]-fluorene, 2-[2,2,3,3,4,4,5,5-octafluoro-1-(nonafluorobutylsulfonyloxyimino)-pentyl]-fluorene 2-[2,2,3,3,4,4,5,5,6,6,7,7-dodecafluoro-1-(nonafluorobutylsulfonyloxyimino)-heptyl]-9-thia-fluorene, 2-[2,2,3,3,4,4,4-heptafluoro-1-(2-trifluoromethylbenzenesulfonyloxyimino)-pentyl]-fluorene, 2-[2,2,3,3,4,4,5,5-octafluoro-1-(2-trifluoromethylbenzenesulfonyloxyimino)-pentyl]-fluorene, α-(methylsulfonyloxyimino)-4-methoxybenzylcyanide, α-(methylsulfonyloxyimino)-3-methoxybenzylcyanide, α-(methylsulfonyloxyimino)-3,4-dimethylbenzylcyanide, α-(methylsulfonyloxyimino)-thiophene-3-acetonitrile, α-(isopropylsulfonyloxyimino)-thiophene-2-acetonitrile or cis/trans-α-(dodecylsulfonyloxyimino)-thiophene-2-acetonitrile. Further suitable oximesulfonates and their preparation can be found, for example, in WO-00/10 972, WO-00/26 219, GB-2348644, U.S. Pat. No. 4,450,598, WO-98/10335, WO-99/01429, EP-0 780 729, EP-0 821 274, U.S. Pat. No. 5,237,059, EP-0 571 330, EP-0 241 423, EP-0 139 609, EP-0 361 907, EP-0 199672, EP-0 048615, EP-0 012 158, U.S. Pat. No. 4,136,055, WO-02/25 376, WO-02/98 870, WO-03/067 332 and WO-04/074 242.

Further photolatent acid donors are described in a review by M. Shirai and M. Tsunooka in Prog. Polym. Sci., Vol. 21, 1-45 [1996] and by J. Crivello, K. Dietliker, “Photoinitiators for Free Radical Cationic & Anionic Photopolymerisation”, 2^{nd} Ed., Volume III in the Series “Chemistry & Technology of UV & EB Formulation for Coatings, Inks & Paints”, John Wiley/SITA Technology Limited, London, 1998, chapter III (pages 329-463).

Suitable sensitizers are for example thioxanthones, benzophenones, coumarins, anthraquinones, 3-(aroylmethylene)-thiazolines, rhodanines, compounds disclosed in WO-06/008251 (page 36/line 30—page 38/line 8), the disclosure of which is hereby incorporated by reference, or other compounds known as sensitizers. Photosensitizer compounds are preferably selected from the group consisting of benzophenone, thioxanthone, coumarin or anthraquinone and derivatives thereof. The amount of sensitizer is preferably from 0 to 200% by weight, especially from 0 to 100% by weight, based on the amount of photoinitiator.

Suitable thioxanthones are for example thioxanthone, 2-isopropylthioxanthone, 2-chlorothioxanthone,1-chloro-4-propoxythioxanthone, 2-dodecylthioxanthone, 2,4-diethylthioxanthone, 2,4-dimethylthioxanthone, 1-methoxy-carbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di-[2-(2-methoxyethoxy)ethoxycarbonyl]-thioxanthone, 1,3-dimethyl-2-hydroxy-9H-thioxanthen-9-one 2-ethylhexylether, 1-ethoxycarbonyl-3-(1-methyl-1-morpholinoethyl )-thioxanthone, 2-methyl-6-dimethoxymethyl-thioxanthone, 2-methyl-6-(1,1-dimethoxybenzyl)-thio-xanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-carboxylic acid polyethyleneglycol ester and 2-hydroxy-3-(3,4-dimethyl-9-oxo-9H-thioxanthon-2-yloxy)-N,N,N-trimethyl-1-propanaminium chloride;

Suitable benzophenones are for example benzophenone, 4-phenyl benzophenone, 4-methoxy benzophenone, 4,4′-dimethoxy benzophenone, 4,4′-dimethyl benzophenone, 4,4′-dichlorobenzophenone 4,4′-bis(dimethylamino)-benzophenone, 4,4′-bis(diethylamino)benzophenone, 4,4′-bis(methylethylamino)benzophenone, 4,4′-bis(p-isopropylphenoxy)benzophenone, 4-methyl benzophenone, 2,4,6-trimethyl-benzophenone, 4-(4-methylthiophenyl)-benzophenone, 3,3′-dimethyl-4-methoxybenzo-phenone, methyl-2-benzoylbenzoate, 4-(2-hydroxyethylthio)-benzophenone, 4-(4-tolylthio)-benzophenone, 1-[4-(4-benzoyl-phenylsulfanyl)-phenyl]-2-methyl-2-(toluene-4-sulfonyl)-prop-an-1-one, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)-benzophenone or 4-benzoyl-N,N-dimethyl-N-[2-(1-oxo-2-propenyl)-oxy]ethyl-benzenemethanaminium chloride.

Suitable coumarins are for example Coumarin 1, Coumarin 2, Coumarin 6, Coumarin 7, Coumarin 30, Coumarin 102, Coumarin 106, Coumarin 138, Coumarin 152, Coumarin 153, Coumarin 307, Coumarin 314, Coumarin 314T, Coumarin 334, Coumarin 337, Coumarin 500, 3-benzoyl coumarin, 3-benzoyl-7-methoxycoumarin, 3-benzoyl-5,7-dimethoxycoumarin, 3-benzoyl-5,7-dipropoxycoumarin, 3-benzoyl-6,8-dichlorocoumarin, 3-benzoyl-6-chloro-coumarin, 3,3′-carbonyl-bis[5,7-di(propoxy)-coumarin], 3,3′-carbonyl-bis(7-methoxycoumarin), 3,3′-carbonyl-bis(7-diethylamino-coumarin), 3-isobutyroylcoumarin, 3-benzoyl-5,7-dimethoxy-coumarin, 3-benzoyl-5,7-diethoxy-coumarin, 3-benzoyl-5,7-dibutoxycoumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-diethoxy-3-(1-naphthoyl)-coumarin, 3-benzoylbenzo[f]coumarin, 7-diethylamino-3-thienoylcoumarin, 3-(4-cyanobenzoyl )-5,7-dimethoxycoumarin, 3-(4-cyanobenzoyl)-5,7-dipropoxycoumarin, 7-dimethylamino-3-phenylcoumarin, 7-diethylamino-3-phenylcoumarin or the coumarin derivatives disclosed in JP-A-H09 /179299 and JP-A-H09/325209, such as 7-[{4-chloro-6-(diethylamino)-S-triazine-2-yl}amino]-3-phenylcoumarin.

Suitable 3-(aroylmethylene)-thiazolines are for example 3-methyl-2-benzoyl-methylene-β-naphthothiazoline, 3-methyl-2-benzoylmethylene-benzothiazoline or 3-ethyl-2-propionylmethylene-β-naphthothiazoline;

Suitable rhodanines are for example 4-dimethylaminobenzalrhodanine, 4-diethylaminobenzalrhodanine, 3-ethyl-5-(3-octyl-2-benzothiazolinylidene)-rhodanine or the rhodanine derivatives of formulae [1], [2], [7] from JP-A-H08/305019.

Other compounds known as sensitizers are acetophenone, 3-methoxyacetophenone, 4-phenylacetophenone, benzil, 4,4′-bis(dimethylamino)benzil, 2-acetylnaphthalene, 2-naphthaldehyde, dansyl acid derivatives, 9,10-anthraquinone, anthracene, pyrene, aminopyrene, perylene, phenanthrene, phenanthrenequinone, 9-fluorenone, dibenzosuberone, curcumin, xanthone, thiomichie's ketone, α-(4-dimethylaminobenzylidene)ketones, such as 2,5-bis(4-diethylaminobenzylidene)-cyclopentanone, 2-(4-di-methylamino-benzylidene)-indan-1-one, 3-(4-dimethyl-amino-phenyl)-1-indan-5-yl-propenone, 3-phenylthiophthalimide, N-methyl-3,5-di-(ethylthio)-phthalimide, N-methyl-3,5-di(ethylthio)-phthalimide, phenothiazine, methylphenothiazine or amines, such as N-phenylglycine, ethyl 4-dimethylaminobenzoate, butoxyethyl 4-dimethylaminobenzoate, 4-dimethylaminoacetophenone, triethanolamine, methyldiethanolamine, dimethylaminoethanol, 2-(dimethylamino)-ethyl benzoate and poly(propylenegylcol)-4-(dimethylamino)benzoate.

Both the photoinitiators and optional sensitizers are preferably chosen so as to initiate polymerisation of the oligomeric component comprising acrylic bonds under irradiation by light of wavelength from 250 to 420 nm (broad UV range), preferably from 320 to 405 nm.

The binder comprising at least one oligomeric component comprising acrylic bonds is preferably an oligomeric epoxy acrylate, aromatic urethane acrylate, aliphatic urethane acrylate or polyester acrylate. Specialty oligomers comprising other acrylates can also be used for specialty, typically low volume applications. The oligomeric component can be a single compound, but it is generally a mixture of compounds, which mixture can be extremely complex and comprise for example from 2 to 1000 compounds, though the maximum number of reactive diluents is not limited in any way, especially when several monomers are copolymerized to obtain the oligomeric component.

The primary function of the reactive diluents in the ink formulation is to lower the viscosity of the oligomer blend, similarly as a solvent. They also contribute to the physical properties of the cured film, such as gloss, hardness and flexibility. Suitable reactive diluents are for example monomers, generally of boiling point from 30 to 200° C. at 1·10⁵ Pa, which comprise from 1 to 8, preferably from 1 to 3 polymerisable bonds, for example acrylic bonds. The use of one or a plurality of reactive diluents is a preferred embodiment of the invention. Preference should be given to non or low toxic reactive diluents (low draize value). When more than one reactive diluent is used, the number of reactive diluents is generally from 2 to 50, usually from 2 to 10, though the maximum number of reactive diluents is of course not limited.

The radiation curing ink of the invention may if desired comprise further components, such as further colourants, rheology improvers, surfactants and/or other additives. Further colourants, such as pigments, dyes or derivatives thereof, are preferably comprised in an amount of from 0 to 10% or 0.1 to 10% by weight, most preferred from 0 to 2% by weight, based on the amount of pigment of formula (I).

Colourless rheology improvers, surfactants and/or other additives are also preferably comprised in an amount of from 0 to 5% or 0.1 to 5% by weight, most preferred from 0.1 to 3% by weight, based on the amount of pigment of formula (I).

Rheology improvers are typically derivatives of colourants or (co)polymers comprising both polar and a polar moieties, such as for example SOLSPERSE® 22000 (Noveon) or EFKAE 6750 (Ciba, both benzidine yellow derivatives), SOLSPERSE® 24000 (graft copolymer of ethylene imine and ε-caprolactam—see U.S. Pat. No. 4,224,212) or SOLSPERSE® 27000 (polyethoxylated β-naphthol). Surfactants are suitably anionic, cationic, amphoteric or non-ionic, such as alkyl-, aryl- or aralkyl sulfates or sulfonates; alkyl-, aryl- or aralkyl phosphates or phosphonates; carboxylic acids; primary, secondary or tertiary amines or quaternary salts of amines, for example tallow trimethyl ammonium chloride; long chain alcohols, alcohol or amine/ethylene oxide condensates, amine oxides or phosphine oxides and castor oil derivatives; betaines, glycinates, or propionates. Further additives are such as commonly used in radiation curing inks, for example stabilizers, such as hindered amine light stabilisers, anti-oxidants or other so-called “thermal in-can stabilisers”, for examples waxes.

Preferably, the binder comprises from 5 to 70% by weight, most preferred from 10 to 65% by weight, of oligomeric component comprising acrylic bonds, based on the total amount of binder. The binder further preferably comprises from 10 to 95% by weight, most preferred from 35 to 90% by weight, of one or more reactive diluents. Optionally, the binder may adequately further comprise from 0 to 30% by weight of a one or a plurality of resins, preferably a resin comprising abietic acid or a rosin derivative, based on the total amount of binder.

The optional resin is preferably selected from the group consisting of tall oil resin, gum rosin, wood rosin, hydrogenated rosin, rosin ester, disproportionated rosin, dimerised rosin, polymerised rosin, phenolic rosin, maleic and fumaric resins. Most suitably, the resin does not react with any other component of the compositions.

The pigments of the formulae (I) and (II) are conveniently supplied as powders, but they may also be supplied as granules, chips or dispersions. The pigment of the formula (I) must be wetted and mechanically dispersed in the radiation curable ink vehicle of substantially different polarity in order to fully optimise its properties. This difficult and energy intensive process used in many ways to be a technically highly challenging step, both to the pigment manufacturer and to the ink maker, and a breakthrough in improving the colour strength at good flow has now surprisingly been obtained by using the compositions of the invention. Up to now, skilled artisans disliked the pigments of the formula (I) because of their known problematic rheology (poor flow), an intrinsic property which did not enable radiation curing inks of high colour strength and excellent gloss to be prepared at sufficient fluidity, particularly for flexographic printing. Surprisingly, the radiation curable inks of the invention show much higher colour strength at same pigmentation level, especially in comparison with prior art inks such as those of WO-2005/056 695, so that the rheology can further be improved by reducing the amount of pigment while keeping the high colour strength and a much better hue matching the requirements of polychrome flexographic or lithographic printing. The gloss and fastness are excellent.

The yellow flexographic or lithographic inks of the invention are particularly useful in multiple colour flexographic or lithographic printing, in which application they are generally used in combination with each a cyan or blue, a magenta or red, and a black ink. These inks can be combined in a set for polychrome flexographic or lithographic printing.

A₁ and A₂ are preferably both

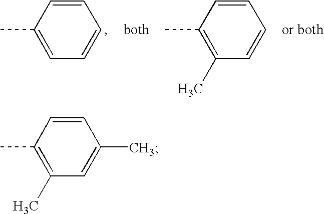

A₃ is preferably

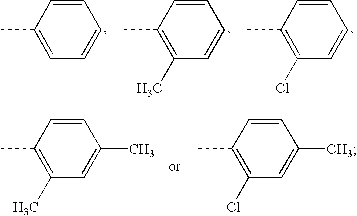

and/or M⁺⁺ is preferably Ca⁺⁺ or Sr⁺⁺.

Especially preferred, A₁ and A₂ are both

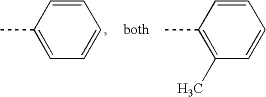

or both

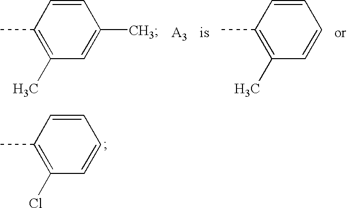

and/or M⁺⁺ is Ca⁺⁺.

All above-mentioned preferences are also valid in combination together, especially when R₁ is H.

Examples of pigments of formula (I) are C.I. Pigment Yellow 12, 13, 14, 17, 55, 63, 81, 83, 87, 106, 113, 114, 121, 124, 126, 127, 136, 171, 172, 174, 176 and 188. Examples of pigments of formula (II) are C.I. Pigment Yellow 61, 62, 133, 168 and 169.

The instant radiation curing inks may be used for example in screen, offset, lithographic, flexographic, gravure or ink-jet printing processes.

Flexography is the preferred printing process, in particular for printing packaging materials such as for example containers, folding cartons, multi-wall sacks, plastic bags, paper sacks, labels or food wrappers. In the typical flexo printing process, the substrate (for example the labels) are fed into the press from a roll. A plate with a raised image or relief is used to transfer the ink to the substrate—only the raised part of the plate comes into contact with the substrate during printing. The printing plate itself is made of a flexible material and attached to a roller. The details are well-known to the skilled artisan.

Nevertheless, lithographic inks having surprisingly improved properties are also obtained. Lithography is a printing process that relies on the mutual repulsion of hydrophobic and hydrophilic areas of a printing press. The imaging part of the printing plate is hydrophobic and the non-imaging part is hydrophilic. When an aqueous ink emulsion is applied to the printing plate, the hydrophobic ink portion selectively migrates to the hydrophobic imaging area whereas the aqueous phase occupies the non-imaging area. The details are well-known to the skilled artisan.

The instant radiation curing ink is preferably prepared from a millbase comprising
from 53⅓ to 78⅔%, preferably 53⅓ to 73⅓%, in particular 53⅓ to 68%, of a binder selected from the group consisting of oligomeric component comprising acrylic bonds, reactive diluents, resins and mixtures thereof;
from 20 to 40%, preferably from 25 to 40%, in particular from 30 to 40%, of a pigment of the formula

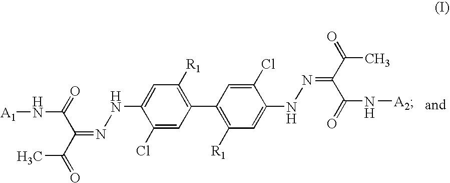

from 1⅓ to 6⅔%, preferably from 1⅔% to 6⅔%, in particular from 2 to 6⅔%, of a pigment of the formula

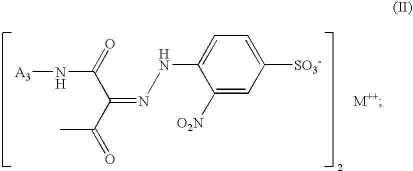

all % by weight, based on the total weight of the millbase.

The millbase is suitably prepared according to methods which are known per se, depending on the milling equipment, milling conditions and optionally wetting or diluting agents, the millbase may come out of the mill for example as a dry or wet powder, a dough, a paste or a suspension, using for example kneaders, extruders, two roll mills, three roll mills, attritors (preferably with zirkonium oxide pearls of size 0.5-10 mm), preferably using a three roll mill.

Surprisingly, the millbases according to the invention are flowable notwithstanding the high pigment concentration, which desirable property enables the skilled artisan to easily pump it out of the storage vessel and to prepare final inks of superior colour strength by simple dilution (letdown), without intensive milling to be necessary. Suitable devices for letdown are dispersers, high-speed stirrers, two roll mills, three roll mills, kneaders, extruders, attritors (adequately 0.5-10 mm but preferably >3 mm), preferably a disperser or high-speed stirrer.

Blending of the pigments of formulae (I) and (II), optionally together with further colourants, can be performed in suspension or preferably dry, or the pigment and/or colourant components can be dispersed simultaneously or in any desired sequential order with liquid components of the composition of the invention (such as oligomeric component, reactive diluent, photoinitiator or sensitizer). Blending can also be performed by wet- or preferably dry-milling together the colourants each independently of the other in the form of a powder, presscake lumps or granules. Blends can also be obtained by mixing, for example by tumbling. Blends can alternatively be obtained by simultaneous or sequential synthesis of the pigments in the same or in connected reactors (mixed synthesis), which process is most adequate when A₃ is identical with A₁, with A₂ or with both A₁ and A₂, followed by washing and drying or flushing. Part or the whole amount of resin may optionally be incorporated upon blending or at any stage of the pigments' synthesis, too.

In a particular, astonishly simple embodiment, a blend can also be prepared by combining an ink comprising a pigment of formula (I) with an ink or millbase comprising a pigment of formula (II), or by combining a millbase comprising a pigment of formula (I) with an ink or millbase comprising a pigment of formula (II). The effect is slightly less remarkable than when the pigments are blended together before preparing the millbase or letdown to the final ink, but it is nevertheless surprisingly significant. Preferred is the combination of two inks or two millbases, but it is also possible to combine each an ink and a millbase in all possible ways.

In a further, very simple method, the pigment of formula (II), either as a dispersion in a liquid component of the ink, or in the form of a powder, presscake lumps or granules, is added to an ink comprising a pigment of formula (I) or to a millbase comprising a pigment of formula (I).

Hence, the invention also pertains to a blend comprising a pigment of the formula

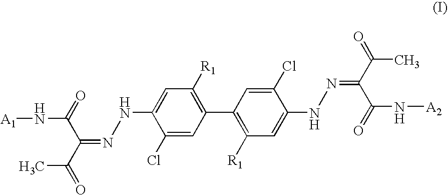

and a pigment of the formula

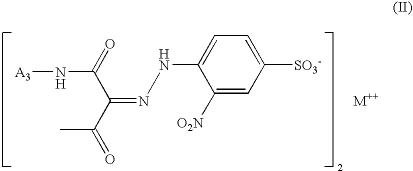

in a weight ratio of from 15:1 to 17:3, preferably for use in radiation curing inks, more preferably flexographic or lithographic radiation curing inks, most preferred flexographic radiation curing inks.

Above blend is preferably a dry solid blend comprising from about 85 to 93¾% of a pigment of the formula

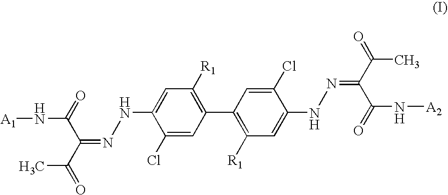

and from 6¼ to about 15% of a pigment of the formula

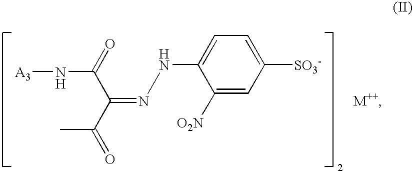

both by weight based on the total weight of the pigments (I) and (II). This blend can optionally be further blended with a solid resin, or one or more of its components can be resinated. In a dry solid blend, the particles of the components are generally distinct from each other, although they can be agglomerated or aggregated. This contrasts for example with solid solutions.

Of course, the instant blends can also advantageously be used for different purposes, such as to colour polymers in the mass (including fibers) or to prepare other types of inks (such as gravure, publishing, packaging, inkjet, pen or security inks), aqueous or solvent-based coatings, electrophotographic toners, electrophotographic developers, colour filters or other conventional preparations.

The examples which follow illustrate the invention, without limiting it (“parts” and “%” are by weight where not otherwise specified):

### EXAMPLE 1

Acetoacet-m-xylidide (40.0 g) is dissolved in a solution of 50% NaOH (15.4 g) and water (250 ml). Acetic acid (6.0 g) and 36% HCl (3.7 g) are diluted with water (80 ml) and added to the coupling component solution over 10 minutes. The pH of the resulting suspension is adjusted to 6.0. The temperature is adjusted to 12° C. and the volume to 400 ml by addition of ice and water. 3,3′-Dichlorobenzidine dihydrochloride (32.6 g), 36% HCl (25.8 g) and water (100 ml) are mixed and cooled to −2° C. by immersion in a salt/ice bath. Sodium nitrite (13.8 g) is dissolved in water (50 ml) and added dropwise to the acidic dichlorobenzidine slurry. Activated charcoal (Actibon® C, 0.2 g) and amorphous silica (Celite®, 0.2 g) are added and the slurry filtered and washed to give a tetrazotated dichlorobenzidine solution which is then added to the coupler suspension over 90 minutes. Addition of the solution is stopped when spotting with H-acid and tetrazotated dichlorobenzidine solution shows a fine end point to the reaction. Throughout the reaction, the temperature is kept below 16° C. and the pH is maintained in the range 4.2-4.8. Triethanolamine monololeate (2.6 g) is emulsified in water (20 ml) using a hotplate stirrer and magnetic flea. This emulsion is added to the pigment slurry in a single portion and the slurry heated to 93° C. by steam injection. The slurry is kept at 93° C. for 1 hour before being cooled to 70° C. by addition of ice. The pH is adjusted to 5.5 and a slurry of C.I. Pigment Yellow 168 (6.7 g, obtained from diazotated acetoaceto-chloroanilide, o-nitroaniline-p-sulfonic acid and calcium chloride) in water (150 ml) is added in a single portion. After stirring for 10 minutes, the suspension is filtered, washed and the residue dried overnight at 70° C.

### EXAMPLE 2

It is proceeded as in example 1, except that no slurry of C.I. Pigment Yellow 168 is added before filtration. Instead, 50 g of the dry pigment thus obtained are blended with 2.5 g of C.I. Pigment Yellow 168 by mixing together in a coffee grinder.

### EXAMPLE 3

It is proceeded as in example 2, with the difference that 50 g of the dry pigment are mixed together with 5.0 g of C.I. Pigment Yellow 168 in a coffee grinder.

### EXAMPLE 4

It is proceeded as in example 2, with the difference that 50 g of the dry pigment are mixed together with 7.5 g of C.I. Pigment Yellow 168 in a coffee grinder.

### EXAMPLE 5

It is proceeded as in example 1, except that the same amount of C.I. Pigment Yellow 62 (obtained from diazotated acetoacet-o-toluidide, o-nitroaniline-p-sulfonic acid and calcium chloride) is used instead of C.I. Pigment Yellow 168.

### EXAMPLE 6

It is proceeded as in example 5, except that no slurry of C.I. Pigment Yellow 62 is added before filtration. Instead,50 g of the dry pigment thus obtained are blended with 2.5 g of C.I. Pigment Yellow 62 by mixing together in a coffee grinder.

### EXAMPLE 7

It is proceeded as in example 6, with the difference that 50 g of the dry pigment are mixed together with 5.0 g of C.I. Pigment Yellow 62 in a coffee grinder.

### EXAMPLE 8

It is proceeded as in example 6, with the difference that 50 g of the dry pigment are mixed together with 7.5 g of C.I. Pigment Yellow 62 in a coffee grinder.

### EXAMPLE 9

It is proceeded as in example 1, except that 37.2 g acetoacet-o-toluidide are used in place of acetoacet-m-xylidide, and a slurry of 8.0 g C.I. Pigment Yellow 133 (obtained from the reaction of diazotated o-nitroaniline-p-sulfonic acid with acetoacetanilide and strontium nitrate) in water (150 ml) is added in place of C.I. Pigment Yellow 168.

### EXAMPLE 10

It is proceeded as in example 1, except that 34.5 g acetoacetanilide are used in place of acetoacet-m-xylidide, and a slurry of 4.9 g C.I. Pigment Yellow 133 (obtained from the reaction of diazotated o-nitroaniline-p-sulfonic acid with acetoacetanilide and strontium nitrate) in water (150 ml) is added in place of C.I. Pigment Yellow 168.

### EXAMPLE 11

It is proceeded as in example 1, except that a mixture of 11.2 g acetoacet-o-toluidide and 28.0 g acetoacet-m-xylidide are used in place of acetoacet-m-xylidide, and a slurry of 8.6 g C.I. Pigment Yellow 133 (obtained from the reaction of diazotated o-nitroaniline-p-sulfonic acid with acetoacetanilide and strontium nitrate) in water (150 ml) is added in place of C.I. Pigment Yellow 168.

### EXAMPLE 12

It is proceeded as in example 1, except that 34.5 g acetoacetanilide is used in place of acetoacet-m-xylidide, and no C.I. Pigment Yellow 168 slurry is added.

### EXAMPLE 13

It is proceeded as in example 1, except that a mixture of 11.2 g acetoacet-o-toluidide and 28.0 g acetoacet-m-xylidide is used in place of acetoacet-m-xylidide, no C.I. Pigment Yellow 168 slurry is added, and 50 g of the dry pigment are instead mixed with 6.8 g of C.I. Pigment Yellow 62.

### EXAMPLE 14

It is proceeded as in example 1, except that no C.I. Pigment Yellow 168 slurry is added.

### EXAMPLE 15

C.I. Pigment Yellow 133 is prepared from the reaction of diazotated o-nitroaniline-p-sulfonic acid with acetoacetanilide and strontium nitrate (alternatively, commercial grade C.I. Pigment Yellow 133 can be used).

### EXAMPLE 16

C.I. Pigment Yellow 62 is prepared from the reaction of diazotated acetoacet-o-toluidide, o-nitroaniline-p-sulfonic acid and calcium chloride (alternatively, commercial grade C.I. Pigment Yellow 62 can be used).

### PREPARATION OF MILLBASES AND INKS FOR EXAMPLES 17-24

A photoinitiator blend is prepared as follows: 27.5 parts of ethyl-4-dimethylamino-benzoate (DAROCUR® EDB, Ciba; amine synergist+hydrogen donor) and 27.5 parts of isopropylthioxanthone (DAROCUR® ITX, Ciba; triplet sensitizer+hydrogen abstractor) are put into a polypropylene container which is placed in an oven (60° C.) until the mixture becomes a clear liquid (about 2-3 hours). 34.0 parts of α,α-dimethoxy-α-phenylacetophenone (IRGACURE® 651, Ciba/hydrogen abstractor) and 11.0 parts of IRGACURE® 379 (α-aminoketone, Ciba/type I photoinitiator) are then manually mixed in and the container is left in the oven (60° C.) overnight to fully dissolve. The solution is then allowed to return to room temperature (−23° C.) where it is a stable, eutectic blend.

A milling varnish is prepared beforehand by mixing 54.9 parts EBECRYL® 812 (polyester acrylate, Cytec Industries Inc., West Paterson, N.J./US), 43.4 parts EBECRYL 83® (amine modified acrylate monomer, Cytec) and 1.70 parts FLORSTAB® UV-1 (in-can stabiliser in polyepoxy acrylate oligomer, Kromachem Ltd, Watford/UK) in a beadmill pot with a trifoil head. The milling varnish is stored in a darkened glass container.

A letdown varnish is prepared beforehand by mixing 48.1 parts EBECRYL 83® (amine modified acrylate monomer, Cytec), 26.4 parts EBECRYL®160 (trimethylol-propanetriacrylate=“TMPEOTA”, Cytec), 6.6 parts tripropyleneglycoldiacrylate (“TPGDA”, Cytec) and 18.7 parts of above photoinitiator blend in a beadmill pot with a trifoil head. The letdown varnish is stored in a darkened glass container.

The millbase is prepared as follows: the pigment (30.0 g) according to the respective example is added to above milling varnish (70.0 g), then premixed manually until fully wetted out. The premix is added to the back rolls of a triple roll mill, equilibrated at 23° C., and mixed for 5 minutes at 1 MPa. The ink is then passed through the mill and returned to the back rolls where it is given a further 2 minutes mix. The ink is then given a second pass at 1 MPa and given a further 2 minutes mix on the back rolls. The millbase ink is then removed from the back rolls for letdown to the final ink.

The final ink is prepared as follows: 4.66 g of above millbase ink from the triple roll mill are weighed directly into the centre of a small speed mix container. 5.34 g of above letdown varnish is then added to the container. The container is closed and placed in the speed mixer which is run for 30 s @1000 r.p.m., 90 s @2000 r.p.m. and finally 60 s @3000 r.p.m. The final ink is stored in a darkened polypropylene container.

### PREPARATION OF MILLBASES AND INKS FOR EXAMPLES 25-32

A photoinitiator blend is prepared as follows: 67 parts of 1-hydroxy-cyclohexyl-phenyl-ketone (IRGACURE® 184, Ciba) and 33 parts of 2-(4-methylbenzyl)-2-(dimethylamino)-1-(4-morpholinophenyl)butan-1-one (IRGACURE® 379, Ciba) are put into a polypropylene container which is placed in an oven (60° C.) until the mixture becomes a clear liquid (about 2-3 hours), which is then allowed to return to room temperature (˜23° C.) where it is a stable, eutectic blend.

A milling varnish is prepared beforehand by mixing EBECRYL® 812 (polyester acrylate, Cytec), EBECRYL® 83 (amine modified acrylate monomer, Cytec) and IRGASTAB® UV-22 (mixture of glycerol, propoxylated, esters with acrylic acid and quinone methide, Ciba) in a beadmill pot with a trifoil head. The milling varnish is stored in a darkened glass container.

A letdown varnish is prepared beforehand by mixing EBECRYL 83® (amine modified acrylate monomer, Cytec), EBECRYL® 160, tripropyleneglycoldiacrylate (“TPGDA”, Cytec) and the above photoinitiator blend in a beadmill pot with a trifoil head. The letdown varnish is stored in a darkened glass container.

The millbase is prepared as follows: the pigment (30.0 g) is added to above milling varnish (70.0 g), then premixed manually until fully wetted out. The premix is added to the back rolls of a triple roll mill, equilibrated at 23° C., and mixed for 5 minutes at 1 MPa. The ink is then passed through the mill and returned to the back rolls where it is given a further 2 minutes mix. The ink is then given a second pass at 1 MPa and given a further 2 minutes mix on the back rolls. The millbase ink is then removed from the back rolls for letdown to the final ink.

The final ink is prepared as follows: the millbase inks from the triple roll mill are weighed directly into the centre of a small speed mix container (mixtures of different millbase inks of same varnish composition are used in examples 27, 31 and 32). The letdown varnish is then added to the container. The container is closed and placed in the speed mixer which is run for 30 s @1000 r.p.m., 90 s @2000 r.p.m. and finally 60 s @3000 r.p.m. The final ink is stored in a darkened polypropylene container.

The respective quantities (parts) of the ingredients are as follows:

| | Pigment | Milling Varnish | | | Let down Varnish | | | | Final Ink | |
|---|---|---|---|---|---|---|---|---|---|---|
| | from | | | IRGASTAB | | | | Photoinitiator | | Let down |
| Example | example | Ebecryl 812 | Ebecryl 83 | UV-22 | Ebecryl 83 | Ebecryl 160 | TPGDA | Blend | Millbase | varnish |
| 25 | 9 | 60.0 | 38.5 | 1.50 | 48.1 | 26.4 | 6.60 | 18.7 | 46.6 | 53.4 |
| 26 | 10 | 52.0 | 46.5 | 1.50 | 48.1 | 24.0 | 5.40 | 22.5 | 46.6 | 53.4 |
| 27 | 12 | 63.0 | 35.5 | 1.50 | 48.1 | 26.4 | 10.3 | 15.0 | 44.3 | 53.4 |
| | 15 | | | | | | | | 2.3 | |
| 28 | 11 | 60 | 38.5 | 1.50 | 48.1 | 26.4 | 6.6 | 18.7 | 38 | 62 |
| 29 | 11 | 65 | 33.5 | 1.5 | 48.1 | 26.4 | 6.6 | 18.7 | 55 | 45 |
| 30 | 13 | 60.0 | 38.5 | 1.50 | 48.1 | 26.4 | 6.6 | 18.7 | 46.6 | 53.4 |
| 31 | 14 | 60.0 | 38.5 | 1.50 | 48.1 | 26.4 | 6.6 | 18.7 | 41.9 | 53.4 |
| | 16 | | | | | | | | 4.7 | |
| 32 | 14 | 60.0 | 38.5 | 1.50 | 48.1 | 26.4 | 6.6 | 18.7 | 41.0 | 53.4 |
| | 15 | | | | | | | | 5.6 | |

### Testing Procedure

### Low Shear Flow (Final Ink Only):

0.5 ml of ink (pre-sheared 2×25 s on a Muller® (small test scale pigment disperser consisting of two glass plates, one of which rotates; the pigment is placed between the glass plates, a weight is applied and one plate is rotated for 25 s, at which point it is a thin film across the surface of the glass, which film is then collected into a single globule and redispersed for a further 25 s) and applied to an inclined plate at 60° C. for 2 hours. The flow is recorded in mm.
Low Shear Flow (after 2 hours) [mm];

### Rheology

A Carri-Med® Controlled Stress Rheometer (TA Instruments Ltd., New Castle, Del./US) equipped with a 6 cm cone for final Inks or a 2 cm cone for millbase inks is used with the continuous shear rate ramp technique (temperature: 23° C., pre-shear 1000 s⁻¹ for 60 s, equilibration 30 s, shear rate ramp 0-600 s⁻¹ in 300 s). The following values are determined:

$$\begin{matrix}\cdot Apparent Viscosity @ 10 {s}^{- 1} & [ \frac{millbase \text{:} Pa \text{-} s}{final ink \text{:} m Pa \text{-} s} ] ; \\ \cdot Apparent Viscosity @ 500 {s}^{- 1} & [ \frac{millbase \text{:} Pa \text{-} s}{final ink \text{:} m Pa \text{-} s} ] ; \\ \cdot Shortness Index = \frac{Viscosity @ 10 {s}^{- 1}}{Viscosity @ 500 {s}^{- 1}} & \begin{matrix}[ dimensionless ] ; \\ this reflects the\end{matrix}\end{matrix}$$

thixotropy of the fluid, values approaching 1 exhibiting a more Newtonian flow.

### Colouristics

The following parameters are determined on Prufbau prints (ladder technique, metal cone, 500 N, 1.0 m·s⁻¹, 25° C., 5692N substrate top-coated white polyethylene, aim for middle weight 1.0 g/m²=80·10⁻⁴ g wet film weight, basic lab minicure set at 54 m/min (5) for curing):
Density measured using a Gretag® 47B densitometer (Gretag-Macbeth or X-Rite Inc, Grand Rapids, Mich./USA);
Colour strength [%] determined instrumentally as compared with standard;
FWT (film weight per unit area) calculated for optical density D=1.2;
Gloss measured using a Mini Glossmaster® (Erichsen GmbH & Co, Hemer/Del.);
Visual assessment for Colour strength (at equal film weight), Shade (at equal density), Colour purity (at equal density), Transparency (at equal film weight) and Gloss (at equal film weight). The usual following abbreviations are used: T=more transparent/O=more opaque/Y=yellower/B=bluer/G=greener/R=redder/E=better/W=worse/P=purer/D=duller/1=very slightly/2=slightly/3=slightly to moderately/4=moderately/5=moderately to considerably/6=considerably/7=extremely.

### EXAMPLES 17-23

Using the ink preparation and testing procedures outlined above, the following values are obtained for the millbases and inks prepared with the pigments according to examples 1-8, as compared with IRGALITE® Yellow BAW (C.I. Pigment Yellow 13, Ciba, not treated with a yellow metal salt) which is used as the standard pigment.

Similar comparative values are obtained with fair reproducibility, though the absolute values may somewhat vary, due to the very complex art of preparing inks and measuring viscosity. A meaningful comparison of values should be done only on results from inks prepared and measured in parallel or within short time sequence, the same operations being performed by the same persons under exactly identical conditions.

### EXAMPLE 24-32

Using the ink preparation and testing procedures outlined above, the following values are obtained for the millbases and inks prepared with the pigments according to examples 9-16, each as compared with the respective pure diarylide pigments (not treated or mixed with a yellow metal salt) incorporated in the same way into the same vehicle formulation.

| | Pigment according to Example: | | | | | | | | |
|---|---|---|---|---|---|---|---|---|---|
| | 1 | 2 | 3 | 4 | 5 | 6 | 7 | 8 | BAW |
| Millbase Rheology | | | | | | | | | |
| Viscosity @ 10 s⁻¹ [Pa · s] | 19.4 | 30.8 | 27.9 | 23.2 | 17.7 | 34.1 | 32.6 | 30.3 | 85.6 |
| Viscosity @ 500 s⁻¹ [Pa · s] | 11.3 | 11.1 | 10.3 | 10.2 | 12.5 | 11.1 | 11.3 | 11.0 | 11.2 |
| Shortness Index | 1.7 | 2.8 | 2.7 | 2.3 | 1.4 | 3.1 | 2.9 | 2.8 | 7.6 |
| Final Ink Rheology | | | | | | | | | |
| Viscosity @ 10 s⁻¹ [Pa · s] | 0.98 | 0.83 | 0.93 | 0.94 | 1.10 | 0.99 | 0.98 | 0.95 | 5.48 |
| Viscosity @ 500 s⁻¹ [Pa · s] | 1.11 | 0.86 | 0.96 | 1.04 | 1.20 | 1.06 | 1.07 | 1.04 | 1.29 |
| Shortness Index | 0.88 | 0.80 | 0.90 | 0.90 | 0.92 | 0.90 | 0.90 | 0.90 | 4.25 |
| Low Shear Flow [mm] | 370 | 196 | 206 | 255 | 171 | 230 | 259 | 300 | 11.3 |
| Colouristics (Prüfbau prints) | | | | | | | | | |
| Colour strength (measured) [%] | 132 | 110 | 108 | 105 | 124 | 114 | 114 | 111 | 100 |
| FWT for optical density D = 1.2 | 0.74 | 0.86 | 0.91 | 0.96 | 0.82 | 0.90 | 0.85 | 0.85 | 1.01 |
| Gloss (absolute value) [%] | 92.0 | 75.8 | 78.1 | 77.0 | 65.9 | 85.1 | 81.8 | 84.6 | 59.8 |
| Gloss (as compared with standard) [%] | 151 | 112 | 116 | 114 | 129 | 126 | 121 | 126 | 100 |
| Visual assessment (Prüfbau prints) | | | | | | | | | |
| Colour strength (at equal film weight) | 130 | 110 | ≦110 | 105 | 115 | 110 | 110 | 105 | 100 |
| Shade (at equal density) | 4G | 2G | 2G | 2G | 2G | 2G | 2G | 2G | std. |
| Colour purity (at equal density) | 2D | 1D | 1D | 1D | 1D | 3D | 3D | 3D | std. |
| Gloss (at equal film weight) | 4E | 1E | 2E | 2E | 3E | 2-3E | 2E | 2-3E | std. |
| Transparency (at equal film weight) | 2T | 2T | 1T | 2T | 3T | 1T | 1T | 1T | std. |

Pigment
according to
Example:

| | 25 | P.Y. 14 |
|---|---|---|
| Millbase Rheology | | |
| Viscosity @ 10 s⁻¹ [Pa · s] | 37.36 | 79.69 |
| Viscosity @ 500 s⁻¹ [Pa · s] | 10.29 | 9.98 |
| Shortness Index | 3.6 | 8.0 |
| Final Ink Rheology | | |
| Viscosity @ 10 s⁻¹ [Pa · s] | 0.761 | 6.37 |
| Viscosity @ 500 s⁻¹ [Pa · s] | 0.775 | 1.36 |
| Shortness Index | 1.00 | 3.22 |
| Low Shear Flow [mm] | 350 | 165 |
| Colouristics (Prüfbau prints) | | |
| Colour strength (measured) [%] | 114 | 100 |
| Gloss (absolute value) [%] | 64.0 | 59.2 |
| Gloss (as compared with standard) [%] | 108 | 100 |
| Visual assessment (Prüfbau prints) | | |
| Colour strength (at equal film weight) | 105 | 100 |
| Shade (at equal density) | 2G | std. |
| Colour purity (at equal density) | 2P | std. |
| Gloss (at equal film weight) | 1O | std. |
| Transparency (at equal film weight) | 1W | std. |

Pigment
according to
Example:

| | 26 | P.Y. 12 |
|---|---|---|
| Millbase Rheology | | |
| Viscosity @ 10 s⁻¹ [Pa · s] | 15.65 | 43.08 |
| Viscosity @ 500 s⁻¹ [Pa · s] | 8.80 | 9.00 |
| Shortness Index | 1.8 | 4.8 |
| Final Ink Rheology | | |
| Viscosity @ 10 s⁻¹ [Pa · s] | 1.13 | 2.30 |
| Viscosity @ 500 s⁻¹ [Pa · s] | 1.00 | 1.10 |
| Shortness Index | 1.13 | 2.1 |
| Low Shear Flow [mm] | >400 | 105 |
| Colouristics (Prüfbau prints) | | |
| Colour strength (measured) [%] | 110.1 | 100 |
| Gloss (absolute value) [%] | 95.3 | 65.4 |
| Gloss (as compared with standard) [%] | 146 | 100 |
| Visual assessment (Prüfbau prints) | | |
| Colour strength (at equal film weight) | ~108 | 100 |
| Shade (at equal density) | 2G | std. |
| Colour purity (at equal density) | 1P | std. |
| Gloss (at equal film weight) | 2E | std. |
| Transparency (at equal film weight) | 2T | std. |

Pigment
according to
Example:

| | 27 | P.Y. 12 |
|---|---|---|
| Millbase Rheology | | |
| Viscosity @ 10 s⁻¹ [Pa · s] | 21.7 | 47.7 |
| Viscosity @ 500 s⁻¹ [Pa · s] | 8.4 | 11.7 |
| Shortness Index | 2.6 | 4.0 |
| Final Ink Rheology | | |
| Viscosity @ 10 s⁻¹ [Pa · s] | 1.29 | 2.05 |
| Viscosity @ 500 s⁻¹ [Pa · s] | 0.93 | 0.88 |
| Shortness Index | 1.4 | 2.3 |
| Low Shear Flow [mm] | 310 | 100 |
| Colouristics (Prüfbau prints) | | |
| Colour strength (measured) [%] | 95.1 | 100 |
| Gloss (absolute value) [%] | 63.0 | 62.0 |
| Gloss (as compared with standard) [%] | 102 | 100 |
| Visual assessment (Prüfbau prints) | | |
| Colour strength (at equal film weight) | 100 | 100 |
| Shade (at equal density) | 1G | std. |
| Colour purity (at equal density) | 2D | std. |
| Gloss (at equal film weight) | 0 | std. |
| Transparency (at equal film weight) | 1T | std. |

Pigment
according to
Example:

| | 28 | P.Y. 174 |
|---|---|---|
| Millbase Rheology | | |
| Viscosity @ 10 s⁻¹ [Pa · s] | 52.3 | 104.6 |
| Viscosity @ 500 s⁻¹ [Pa · s] | 12.1 | 13.1 |
| Shortness Index | 4.3 | 8.0 |
| Final Ink Rheology | | |
| Viscosity @ 10 s⁻¹ [Pa · s] | 1.12 | 4.82 |
| Viscosity @ 500 s⁻¹ [Pa · s] | 1.25 | 1.42 |
| Shortness Index | 0.9 | 3.4 |
| Low Shear Flow [mm] | 265 | 35 |
| Colouristics (Prüfbau prints) | | |
| Colour strength (measured) [%] | 107.9 | 100 |
| Gloss (absolute value) [%] | 64.9 | 59.9 |
| Gloss (as compared with standard) [%] | 108 | 100 |
| Visual assessment (Prüfbau prints) | | |
| Colour strength (at equal film weight) | ~98 | 100 |
| Shade (at equal density) | 3G | std. |
| Colour purity (at equal density) | 2P | std. |
| Gloss (at equal film weight) | 2E | std. |
| Transparency (at equal film weight) | 2T | std. |

Pigment
according to
Example:

| | 29 | P.Y. 174 |
|---|---|---|
| Millbase Rheology | | |
| Viscosity @ 10 s⁻¹ [Pa · s] | 65.8 | 104.7 |
| Viscosity @ 500 s⁻¹ [Pa · s] | 15.8 | 13.9 |
| Shortness Index | 4.2 | 7.5 |
| Final Ink Rheology | | |
| Viscosity @ 10 s⁻¹ [Pa · s] | 2.76 | 5.03 |
| Viscosity @ 500 s⁻¹ [Pa · s] | 0.72 | 1.54 |
| Shortness Index | 3.8 | 3.2 |
| Low Shear Flow [mm] | 225 | 30 |
| Colouristics (Prüfbau prints) | | |
| Colour strength (measured) [%] | 100.8 | 100 |
| Gloss (absolute value) [%] | 61.9 | 71.2 |
| Gloss (as compared with standard) [%] | 87 | 100 |
| Visual assessment (Prüfbau prints) | | |
| Colour strength (at equal film weight) | ~98 | 100 |
| Shade (at equal density) | 3G | std. |
| Colour purity (at equal density) | 2P | std. |
| Gloss (at equal film weight) | 2E | std. |
| Transparency (at equal film weight) | 2T | std. |

Pigment
according to
Example:

| | 30 | P.Y. 174 |
|---|---|---|
| Millbase Rheology | | |
| Viscosity @ 10 s⁻¹ [Pa · s] | 52.0 | 92.8 |
| Viscosity @ 500 s⁻¹ [Pa · s] | 12.1 | 10.8 |
| Shortness Index | 4.3 | 8.6 |
| Final Ink Rheology | | |
| Viscosity @ 10 s⁻¹ [Pa · s] | 1.12 | 3.90 |
| Viscosity @ 500 s⁻¹ [Pa · s] | 1.29 | 1.40 |
| Shortness Index | 0.9 | 2.8 |
| Low Shear Flow [mm] | 380 | 55 |
| Colouristics (Prüfbau prints) | | |
| Colour strength (measured) [%] | 101.5 | 100 |
| Gloss (absolute value) [%] | 69.8 | 51.0 |
| Gloss (as compared with standard) [%] | 137 | 100 |
| Visual assessment (Prüfbau prints) | | |
| Colour strength (at equal film weight) | 100 | 100 |
| Shade (at equal density) | 1G | std. |
| Colour purity (at equal density) | 1P | std. |
| Gloss (at equal film weight) | 1E | std. |
| Transparency (at equal film weight) | 1T | std. |

| | Pigment according to Example: | | |
|---|---|---|---|
| | 31 | 32 | P.Y. 174 |
| Millbase Rheology | | | |
| Viscosity @ 10 s⁻¹ [Pa · s] | 29.4 | 60.3 | 102.1 |
| Viscosity @ 500 s⁻¹ [Pa · s] | 8.0 | 9.0 | 13.6 |
| Shortness Index | 3.7 | 6.7 | 7.5 |
| Final Ink Rheology | | | |
| Viscosity @ 10 s⁻¹ [Pa · s] | 0.87 | 1.10 | 1.80 |
| Viscosity @ 500 s⁻¹ [Pa · s] | 0.97 | 1.18 | 1.26 |
| Shortness Index | 0.9 | 0.9 | 1.4 |
| Low Shear Flow [mm] | >400 | 320 | 102 |
| Colouristics (Prüfbau prints) | | | |
| Colour strength (measured) [%] | 111.9 | 93.9 | 100 |
| Gloss (absolute value) [%] | 66.2 | 59.5 | 59.9 |
| Gloss (as compared with standard) [%] | 111 | 99 | 100 |
| Visual assessment (Prüfbau prints) | | | |
| Colour strength (at equal film weight) | 105 | ~98 | 100 |
| Shade (at equal density) | 1G | 2G | std. |
| Colour purity (at equal density) | 1P | 1D | std. |
| Gloss (at equal film weight) | 1E | 1E | std. |
| Transparency (at equal film weight) | 1T | 1T | std. |

1. A radiation curing ink comprising
from 60 to 90% of a binder comprising at least one oligomeric component comprising acrylic bonds, optionally one or a plurality of reactive diluents and optionally one or a plurality of resins;
from 1 to 20% of a photoinitiator and optionally a sensitizer;
from 5 to 25% of a pigment of the formula 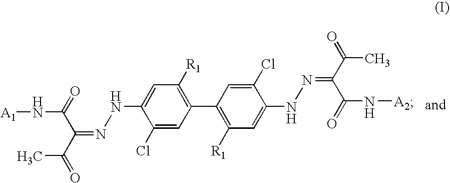
from 0.5 to 2.5% of a pigment of the formula 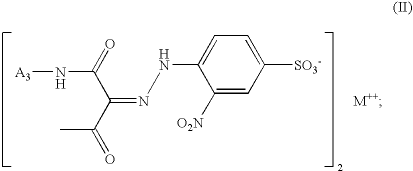
in which formulae (I) and (II) A₁, A₂ and A₃ are each independently from each 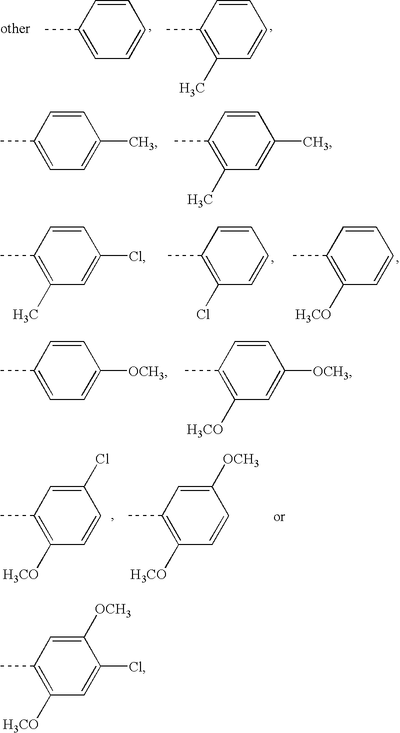
R₁ is H or Cl, and M⁺⁺ is Be⁺⁺, Mg⁺⁺, Ca⁺⁺, Sr⁺⁺ or Ba⁺⁺;
all % by weight, based on the total weight of the radiation curing ink.

2. A radiation curing ink according to claim 1, wherein the photoinitiator is chosen from the group consisting of radical photoinitiators, cationic photoinitiators (latent acids) and anionic photoinitiators (latent bases), and mixtures thereof.

3. A radiation curing ink according to claim 2, comprising a radical photoinitiator.

4. A radiation curing ink according to claim 1, wherein the binder comprising at least one oligomeric component comprising acrylic bonds is an oligomeric epoxy acrylate, aromatic urethane acrylate, aliphatic urethane acrylate or polyester acrylate.

5. A radiation curing ink according to claim 1, which further comprises from 0 to 10% by weight of a further colourant and/or from 0 to 5% by weight of further colourless components selected from the group consisting of rheology improvers, surfactants and/or other additives, each based on the amount of pigment of formula (I).

6. A millbase comprising
from 53⅓ to 78⅔%, preferably 53⅓ to 73⅓%, in particular 53⅓ to 68%, of a binder selected from the group consisting of oligomeric component comprising acrylic bonds, reactive diluents, resins and mixtures thereof;
from 20 to 40%, preferably from 25 to 40%, in particular from 30 to 40%, of a pigment of the formula 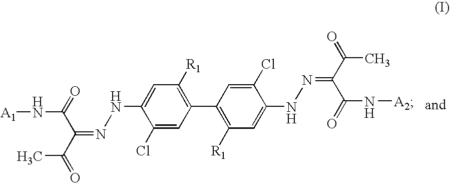
from 1⅓ to 6⅔%, preferably from 1⅔ to 6⅔%, in particular from 2 to 6⅔%, of a pigment of the formula 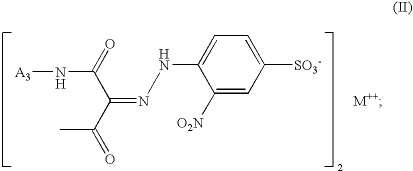
in which formulae (I) and (II) A₁, A₂ and A₃ are each independently from each other 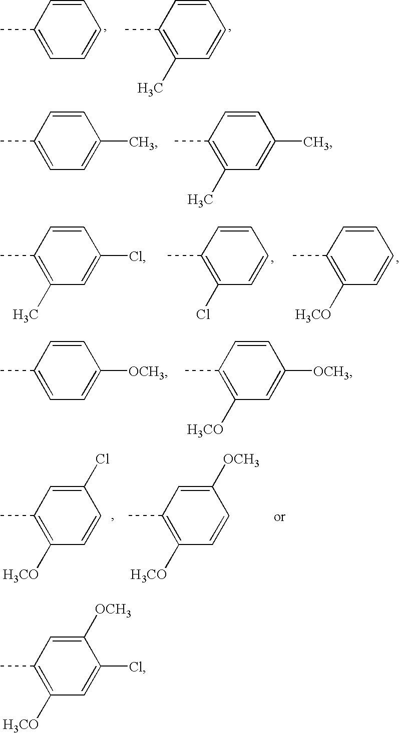
R₁ is H or Cl, and M⁺⁺ is Be⁺⁺, Mg⁺⁺, Ca⁺⁺, Sr⁺⁺ or Ba⁺⁺;
all % by weight, based on the total weight of the millbase.

7. A blend comprising a pigment of the formula 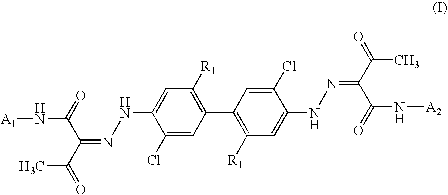
and a pigment of the formula 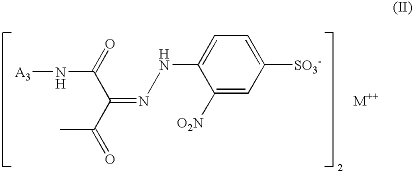
in a weight ratio of from 15:1 to 17:3, in which formulae (I) and (II) A₁, A₂ and A₃ are each independently from each other 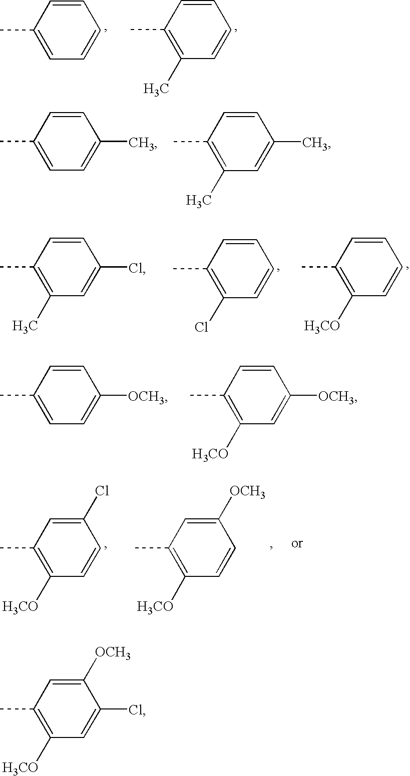
R₁ is H or Cl, and M⁺⁺ is Be⁺⁺, Mg⁺⁺, Ca⁺⁺, Sr⁺⁺ or Ba⁺⁺.

8. A blend according to claim 7, which is a dry solid blend comprising from about 85 to 93¾% of a pigment of the formula 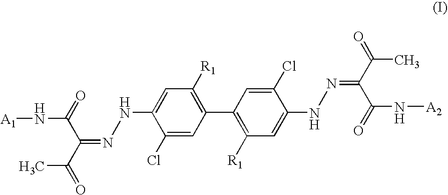
and from 6¼ to about 15% of a pigment of the formula 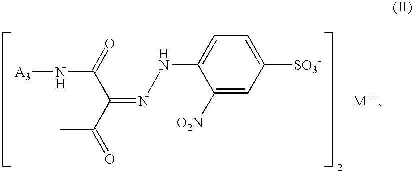
both by weight based on the total weight of the pigments (I) and (II).

9. A process for the manufacture of a blend according to claim 7, wherein the pigments of formulae (I) and (II) are wet- or dry-milled or mixed together, and optionally together with further colourants, each independently of the other in the form of a powder, presscake lumps or granules.

10. A process for the manufacture of a radiation curing ink according to claim 1, wherein an ink comprising a pigment of formula (I) is combined with an ink or millbase comprising a pigment of formula (II), or a millbase comprising a pigment of formula (I) is combined with an ink or millbase comprising a pigment of formula (II).

11. A process for the manufacture of a radiation curing ink according to claim 1, wherein the pigments of formulae (I) and (II) are dispersed simultaneously or in any desired sequential order with liquid components of the radiation curing ink.

12. A process for the manufacture of a radiation curing ink according to claim 1, wherein the pigments of formulae (I) and (II) are made by simultaneous or sequential synthesis in the same or in connected reactors, followed by washing and drying or flushing.

13. A process for the manufacture of a radiation curing ink or millbase according to claim 1, wherein the pigment of formula (II) is added to an ink comprising a pigment of formula (I) either as a dispersion in a liquid component of the ink or in the form of a powder, presscake lumps or granules.

14. A set of inks for polychrome flexographic or lithographic printing comprising a yellow ink according to claim 1 and each of a cyan or blue, a magenta or red, and a black ink.

15. A radiation curing ink or ink millbase comprising a blend according to claim 7.

16. A radiation curing ink comprising a millbase according to claim 6.

17. A radiation curing ink according to claim 4, which further comprises from 0.1 to 10% by weight of a further colourant and /or from 0.1 to 5% by weight of further colourless components selected from the group consisting of rheology improvers, surfactants and/or other additives, each based on the amount of pigment of formula (I).

18. A process for the manufacture of a millbase according to claim 6, wherein a millbase comprising a pigment of formula (I) is combined with a millbase comprising a pigment of formula (II).

19. A process according to claim 12 wherein in formulae (I) and (II) A₃ is identical with A₁, with A₂ or with both A₁ and A₂.

20. A process for the manufacture of a millbase according to 6, wherein the pigments of formulae (I) and (II) are made by simultaneous or sequential synthesis in the same or in connected reactors, followed by washing and drying or flushing.
